(19) United States
(12) Patent Application Publication
(10) Pub. No.: US 2024/0413589 A1
(43) Pub. Date: Dec. 12, 2024

(54) ELECTRICAL CONNECTOR

(71) Applicant: SUMITOMO ELECTRIC INDUSTRIES, LTD., Osaka (JP)

(72) Inventor: Yasunori ASANO, Osaka-shi (JP)

(73) Assignee: SUMITOMO ELECTRIC INDUSTRIES, LTD., Osaka (JP)

(21) Appl. No.: 18/629,322

(22) Filed: Apr. 8, 2024

(30) Foreign Application Priority Data
Jun. 7, 2023 (JP) 2023-093999

(51) Int. Cl. H01R 13/6585; H01R 13/629

(52) U.S. Cl. CPC H01R 13/6585; H01R 13/629

(57) ABSTRACT

An electrical connector includes a plurality of first electric wires including a first signal line and a first ground line connected to a ground, each extending in a first direction, and arranged in a second direction intersecting with the first direction, a housing including a first holding portion that holds each tip end portion of the plurality of first electric wires, and a first ground plate including a plate main body provided on the housing. The first holding portion holds each conductor at each tip end portion of the plurality of first electric wires. The first ground plate includes an elastic member extending from the plate main body toward the conductor of the first ground line. The elastic member is configured to come into elastic contact with the conductor of the first ground line.

### TECHNICAL FIELD

The present disclosure relates to an electrical connector. This application is based upon and claims the benefit of priority from Japanese Patent Application No. 2023-093999, filed on Jun. 7, 2023, the entire contents of which are incorporated herein by reference.

### BACKGROUND

JP2017-069166A discloses an electrical connector that is connected to a mating electrical connector. This electrical connector includes a plurality of electric wires and a housing holding the plurality of electric wires.

### SUMMARY

The present disclosure relates, in one aspect, to an electrical connector. The electrical connector includes a plurality of first electric wires, a housing, and a first ground plate. The plurality of first electric wires includes a first signal line and a first ground line connected to a ground. Each of the plurality of first electric wires extends in a first direction, and the plurality of first electric wires are arranged in a second direction intersecting with the first direction. The housing includes a first holding portion that holds each tip end portion of the plurality of first electric wires. The first ground plate includes a plate main body provided on the housing. In this electrical connector, the first holding portion holds each conductor at each tip end portion of the plurality of first electric wires. The first ground plate includes an elastic member extending from the plate main body toward the conductor of the first ground line. The elastic member is configured to come into elastic contact with the conductor of the first ground line.

### BRIEF DESCRIPTION OF THE DRAWINGS

FIG. 1 is a perspective view showing an electrical connector according to an embodiment.

FIG. 2 is an exploded perspective view of the electrical connector shown in FIG. 1.

FIG. 3 is a perspective view showing a sub-connector included in the electrical connector shown in FIG. 1.

FIG. 4 is a cross-sectional view of the sub-connector shown in FIG. 3 along line IV-IV.

FIG. 5 is a cross-sectional view of the sub-connector shown in FIG. 3 along line V-V.

### DETAILED DESCRIPTION

### Problems to be Solved by the Present Disclosure

In an electrical connector such as that disclosed in JP2017-069166A, noise is more likely to occur in electric wires as transmission speed of signals increase. In order to reduce such noise, it is conceivable to connect conductors of any electric wires of the plurality of electric wires to a ground. It is desired to further reduce such noise for preventing increase in transmission loss. On the other hand, it is also desired that such an electrical connector be made smaller.

### Effects of the Present Disclosure

According to the present disclosure, it is possible to provide an electrical connector that can achieve both prevention of increase in transmission loss and miniaturization of the connector.

### DESCRIPTION OF EMBODIMENT OF THE PRESENT DISCLOSURE

First, the content of an embodiment of the present disclosure will be listed and described.
(1) An electrical connector according to an embodiment of the present disclosure includes a plurality of first electric wires, a housing, and a first ground plate. The plurality of first electric wires includes a first signal line and a first ground line connected to a ground. Each of the plurality of first electric wires extends in a first direction, and the plurality of first electric wires are arranged in a second direction intersecting with the first direction. The housing includes a first holding portion that holds each tip end portion of the plurality of first electric wires. The first ground plate includes a plate main body provided on the housing. In this electrical connector, the first holding portion holds each conductor at each tip end portion of the plurality of first electric wires. The first ground plate includes an elastic member extending from the plate main body toward the conductor of the first ground line. The elastic member is configured to come into elastic contact with the conductor of the first ground line.

The electrical connector includes the first ground line connected to the ground and the first ground plate, and the first ground plate is in contact with the conductor of the first ground line. As a result, it is possible to further reduce the noise generated in the electrical connector. Furthermore, in this electrical connector, the first ground plate is in elastic contact with the conductor of the first ground line by the elastic member extending from the plate main body. As a result, even in a case where such a first ground plate is provided, there is no need to use a terminal or the like for connecting the first ground plate to the ground, and thus the electrical connector can be made smaller. Therefore, according to this electrical connector, it is possible to achieve both prevention of increase in transmission loss and miniaturization of the connector.
(2) In the electrical connector according to (1) above, the first holding portion may include a plurality of through holes that penetrate the housing in the first direction. Each tip end portion of the plurality of first electric wires may be received in each of the plurality of through holes. In this case, the first holding portion that holds the plurality of first electric wires can be easily formed. Furthermore, the first holding portion can stably hold the plurality of first electric wires.
(3) In the electrical connector according to (1) or (2) above, the housing may include a first surface and a second surface located on a side opposite to the first surface in the first direction. The first holding portion may be open on the first surface and the second surface. Each tip end of the plurality of first electric wires may be exposed from the first holding portion on the first surface. The housing may include a step that protrudes from the second surface in the first direction, and the conductor of the first ground line may be sandwiched between the step and the elastic member. In this case, the elastic member can be brought into more reliable contact with the conductor of the first ground line, and the contact of the elastic member with the conductor of the first ground line can be stably maintained over a long period of time.
(4) In the electrical connector according to (3) above, the step may include a groove that supports the conductor of the first ground line, and the elastic member may have a shape that protrudes toward the conductor of the first ground line. In this case, the elastic member can be brought into more reliable contact with the conductor of the first ground line and the contact of the elastic member with the conductor of the first ground line can be stably maintained over a long period of time.
(5) The electrical connector according to any one of (1) to (4) above may further include a plurality of second electric wires and a second ground plate. The plurality of second electric wires includes a second signal line and a second ground line connected to a ground. Each second electric wire extends in the first direction, and the plurality of second electric wires are arranged in the second direction. The housing may include a second holding portion that holds each tip end portion of the plurality of second electric wires. The plurality of second electric wires may be aligned with the plurality of first electric wires in a third direction intersecting with both the first direction and the second direction. The second ground plate may be located between the plurality of first electric wires and the plurality of second electric wires. In this case, the plurality of second electric wires are further provided, and thus the amount of signal transmission can be increased. Furthermore, since the second ground plate is located between the plurality of first electric wires and the plurality of second electric wires, it is possible to prevent noise generated in the first electric wires from entering the second electric wires, and it is possible to prevent noise generated in the second electric wires from entering the first electric wires.
(6) The electrical connector according to any one of (1) to (5) above may further include a covering member that covers at least portions of the plurality of first electric wires other than each tip end portion thereof. The plurality of first electric wires may be integrated by the covering member. In this case, it is easier to hold the plurality of first electric wires in the first holding portion of the housing.

### DETAILS OF EMBODIMENTS OF THE PRESENT DISCLOSURE

A specific example of an electrical connector according to the present embodiment will be described with reference to the drawings as necessary. The present disclosure is not limited to these examples, but is defined by the scope of the claims, and is intended to include meanings equivalent to the scope of the claims and all modifications within the scope. In the following description, the same elements will be denoted by the same reference signs in the description of the drawings, without redundant description.

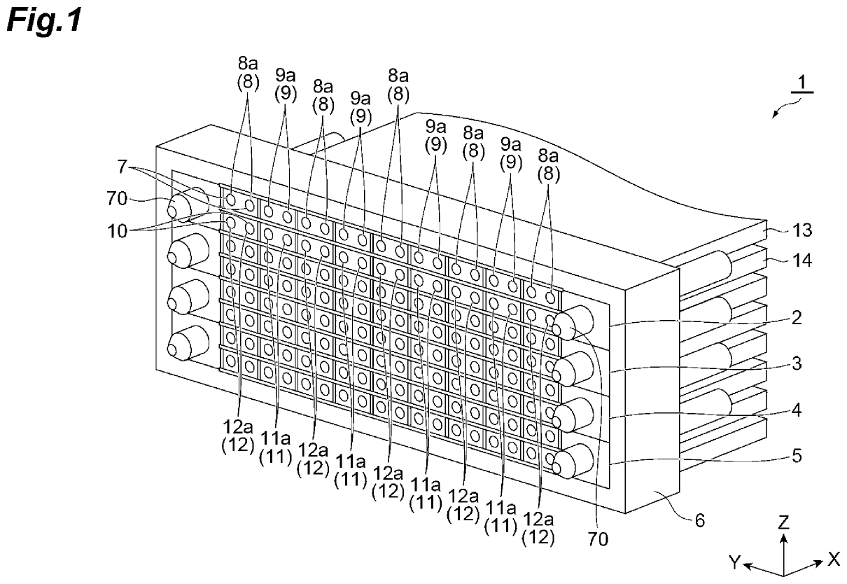

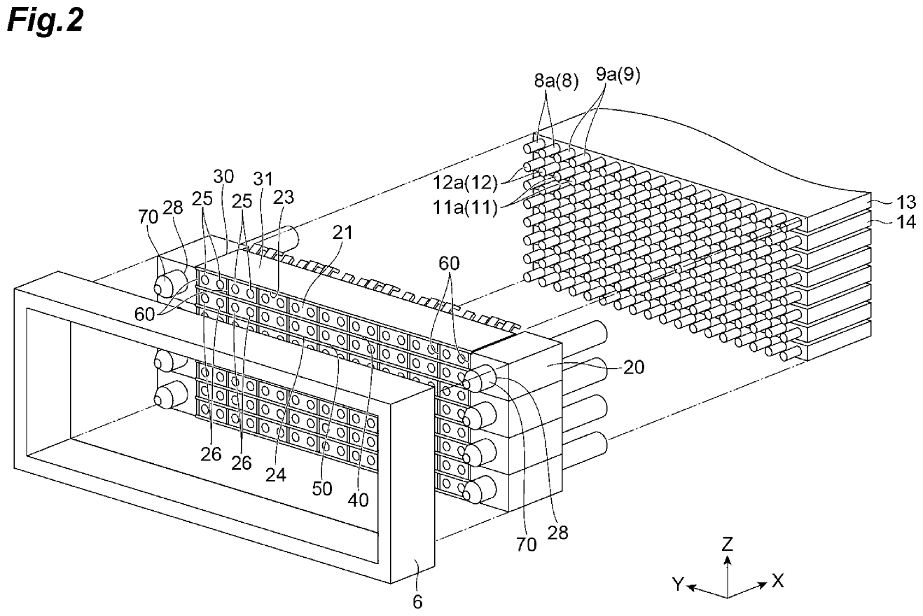

FIG. 1 is a perspective view showing an electrical connector 1 according to an embodiment. FIG. 2 is an exploded perspective view of the electrical connector 1 shown in FIG. 1. The electrical connector 1 is attached to a board (not shown) with a mating connector (not shown), for example. The electrical connector 1 includes sub-connectors 2, 3, 4, and 5 and a frame 6. The sub-connectors 2 to 5 are held by the frame 6. The sub-connectors 3, 4, and 5 have the same configuration as the sub-connector 2. For this reason, hereinafter, the details of the sub-connector 2 will be explained, and the explanation of the sub-connectors 3, 4, and 5 may be omitted.

The sub-connector 2 includes a plurality of first electric wires 7, a plurality of second electric wires 10, a housing 20, ground plates 30, 40, and 50, a plurality of shield members 60, and a pair of guide pins 70. The plurality of first electric wires 7 are integrated by a covering member 13 to form a flexible flat cable (FFC). Similarly, the plurality of second electric wires 10 are integrated by a covering member 14 to form an FFC.

The plurality of first electric wires 7 are members for transmitting electric power or electric signals. Each first electric wire 7 is either a signal line 8 (a first signal line) or a ground line 9 (a first ground line). In one example, the plurality of first electric wires 7 include five pairs of (ten) signal lines 8 and four pairs of (eight) ground lines 9. Each of the signal lines 8 has a conductor 8a. The conductor 8a is formed from a metal such as copper. When the electrical connector 1 is connected to the mating connector, the conductor 8a is connected to a circuit on the board with a terminal provided on the mating connector. The conductor 8a may be directly connected to an electrode pad provided on the board. The signal line 8 may be an insulated wire in which the conductor 8a is covered with an insulator, or may be a bare wire in which the conductor 8a is exposed as it is. Each of the ground lines 9 has a conductor 9a. The conductor 9a is formed from a metal such as copper. For example, when the electrical connector 1 is connected to the mating connector, the conductor 9a is connected to a ground with a ground terminal provided on the mating connector. The conductor 9a may be directly connected to an electrode pad provided on the board. The ground line 9 may be an insulated wire in which the conductor 9a is covered with an insulator, or may be a bare wire in which the conductor 9a is exposed as it is. In a case where the ground line 9 is an insulated wire, a part of the insulator of the insulated wire is removed and the conductor 9a is exposed such that an elastic member 32 of the ground plate 30 comes into contact with the conductor 9a, as will be described below.

The plurality of first electric wires 7 each extend in an X direction. The plurality of first electric wires 7 are arranged in a Y direction perpendicular to the X direction. In one example, the pairs of signal lines 8 and the pairs of ground lines 9 are alternately aligned in the Y direction. The pair of adjacent signal lines 8 carry currents in phases opposite to each other, and transmit signals through differential transmission in which signals are transmitted using a potential difference between the pair of signal lines 8. The distance between the conductors (the distance between centers) of the plurality of first electric wires 7 is, for example, 0.6 mm.

The plurality of second electric wires 10 are members for transmitting electric power or electric signals. Each second electric wire 10 is either a signal line 11 (a second signal line) or a ground line 12 (a second ground line). In one example, the plurality of second electric wires 10 include four pairs of (eight) signal lines 11 and five pairs of (ten) ground lines 12. Each of the signal lines 11 has a conductor 11a. The conductor 11a is formed from a metal such as copper. When the electrical connector 1 is connected to the mating connector, the conductor 11a is connected to a circuit on the board with a terminal provided on the mating connector. The conductor 11a may be directly connected to an electrode pad provided on the board. The signal line 11 may be an insulated wire in which the conductor 11a is covered with an insulator, or may be a bare wire in which the conductor 11a is exposed as it is. Each of the ground lines 12 has a conductor 12a. The conductor 12a is formed from a metal such as copper. When the electrical connector 1 is connected to the mating connector, the conductor 12a is connected to a ground with a ground terminal provided on the mating connector. The conductor 12a may be directly connected to an electrode pad provided on the board. The ground line 12 may be an insulated wire in which the conductor 12a is covered with an insulator, or may be a bare wire in which the conductor 12a is exposed as it is. In a case where the ground line 12 is an insulated wire, a part of the insulator of the insulated wire is removed and the conductor 12a is exposed such that the elastic member (not shown) of the ground plate 50 comes into contact with the conductor 12a, as will be described below.

The plurality of second electric wires 10 each extend in the X direction. The plurality of second electric wires 10 are aligned in the Y direction. The plurality of second electric wires 10 are aligned with the plurality of first electric wires 7 in a Z direction perpendicular to both the X direction and the Y direction. In one example, a pair of (two) signal lines 11 and a pair of (two) ground lines 12 are alternately aligned in the Y direction. The pair of adjacent signal lines 11 carry currents in phases opposite to each other, and transmit signals through differential transmission in which signals are transmitted using a potential difference between the pair of signal lines 11. The distance between the conductors (the distance between centers) of the plurality of second electric wires 10 is, for example, 0.6 mm.

The pair of signal lines 11 are aligned with the pair of ground lines 9 in the Z direction. The pair of ground lines 12 are aligned with the pair of signal lines 8 in the Z direction. That is, in the sub-connector 2, the pair of signal lines 8 and the pair of signal lines 11 are disposed in a staggered (zigzag) pattern, and the pair of ground lines 9 and the pair of ground lines 12 are disposed in a staggered (zigzag) pattern different from the arrangement of the pairs of signal lines 8 and 11.

The covering member 13 is a member that covers the portions of the plurality of first electric wires 7 other than the tip end portions and the rear end portions thereof. The material of the covering member 13 is, for example, a resin such as polyester. A portion of the covering member 13 that covers the tip end portions of the conductors 8a of the signal lines 8 and the tip end portions of the conductors 9a of the ground lines 9 has been removed. That is, the tip end portions of the conductors 8a of the signal lines 8 and the tip end portions of the conductors 9a of the ground lines 9 are exposed from the covering member 13.

The covering member 14 is a member that covers the portions of the plurality of second electric wires 10 other than the tip end portions and the rear end portions thereof. The material of the covering member 14 is, for example, a resin such as polyester. A portion of the covering member 14 that covers the tip end portions of the conductors 11a of the signal lines 11 and the tip end portions of the conductors 12a of the ground lines 12 has been removed. That is, the tip end portions of the conductors 11a of the signal lines 11 and the tip end portions of the conductors 12a of the ground lines 12 are exposed from the covering member 14.

The housing 20 is a rectangular parallelepiped-shaped member that holds the plurality of first electric wires 7 and the plurality of second electric wires 10. The material of the housing 20 is formed from a resin such as polyphenylene sulfide (PPS). The housing 20 has a first surface 21, a second surface 22, a third surface 23, and a fourth surface 24. The first surface 21 and the second surface 22 are surfaces extending in the Y direction and the Z direction. The second surface 22 is located on a side opposite to the first surface 21 in the X direction. The third surface 23 and the fourth surface 24 are surfaces extending in the X direction and the Y direction. The fourth surface 24 is located on a side opposite to the third surface 23 in the Z direction.

The housing 20 further includes a plurality of first through holes 25 (a first holding portion), a plurality of second through holes 26 (a second holding portion), a step 27, and a pair of guide holes 28.

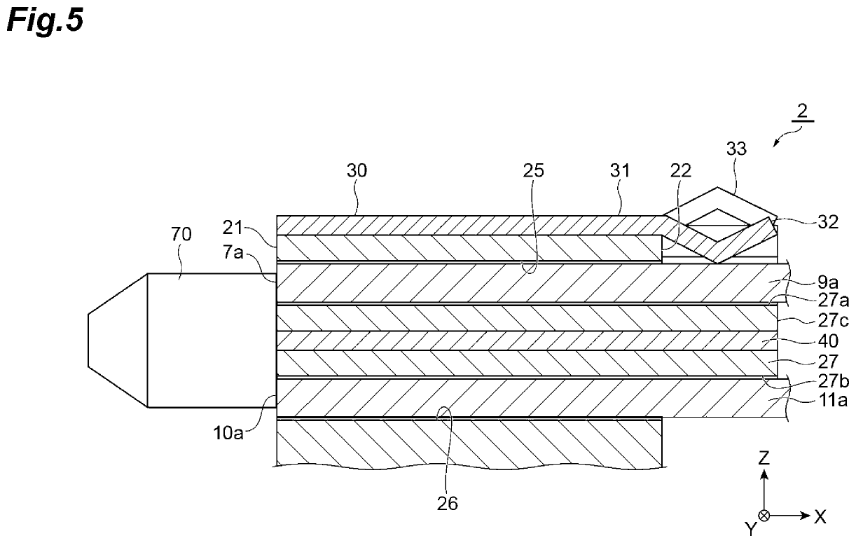

The first through hole 25 is a hole that penetrates the housing 20 in the X direction. The first through hole 25 is open on the first surface 21 and the second surface 22. The shape of the first through hole 25 when viewed in the X direction is, for example, a circular shape. In the present embodiment, eighteen first through holes 25 are formed in the housing 20. The plurality of first through holes 25 are aligned in the Y direction. The inner diameter of each of the first through holes 25 is the same as or slightly larger than the outer diameter of the conductor 8a of the signal line 8 and the outer diameter of the conductor 9a of the ground line 9. Either the conductor 8a of the signal line 8 or the conductor 9a of the ground line 9 is disposed inside each first through hole 25. Each first through hole 25 receives the tip end portion of the first electric wire 7. Each first through hole 25 holds the conductor at the tip end portion of the first electric wire 7. Each tip end 7a (see FIG. 5) of the plurality of first electric wires 7 is exposed from each of the plurality of first through holes 25 on the first surface 21.

The second through hole 26 is a hole that penetrates the housing 20 in the X direction. The second through hole 26 is open on the first surface 21 and the second surface 22. The shape of the second through hole 26 when viewed in the X direction is, for example, a circular shape. In the present embodiment, eighteen second through holes 26 are formed in the housing 20. The plurality of second through holes 26 are aligned in the Y direction. The plurality of second through holes 26 are aligned with the plurality of first through holes 25 in the Z direction. The inner diameter of each of the second through holes 26 is the same as or slightly larger than the outer diameter of the conductor 11a of the signal line 11 and the outer diameter of the conductor 12a of the ground line 12. Either the conductor 11a of the signal line 11 or the conductor 12a of the ground line 12 is disposed inside each second through hole 26. Each second through hole 26 receives the tip end portion of the second electric wire 10. Each second through hole 26 holds the conductor at the tip end portion of the second electric wire 10. Each tip end 10a (see FIG. 5) of the plurality of second electric wires 10 is exposed from each of the plurality of second through holes 26 on the first surface 21.

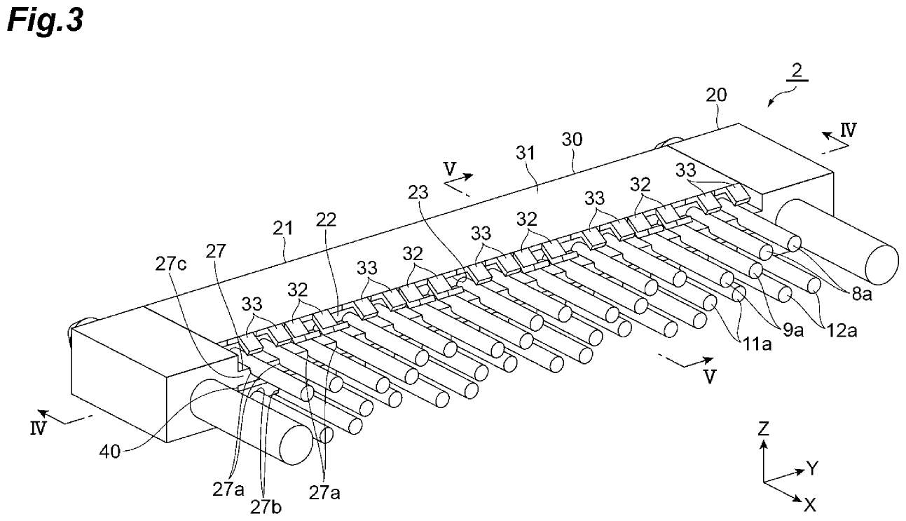

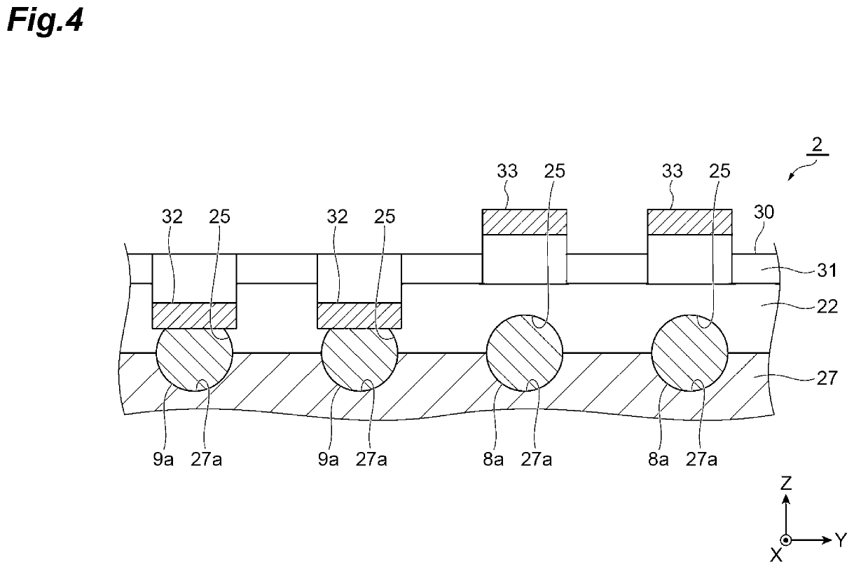

The step 27 will be explained with reference to FIGS. 3 and 4. FIG. 3 is a perspective view showing the sub-connector 2. FIG. 4 is a cross-sectional view of the sub-connector 2 shown in FIG. 3 along line IV-IV. In FIG. 3, illustration of the covering members 13 and 14 is omitted. The step 27 is provided on the second surface 22. The shape of the step 27 is a rectangular parallelepiped. The step 27 protrudes from the second surface 22 in the X direction. The step 27 is located between the plurality of first electric wires 7 and the plurality of second electric wires 10 in the Z direction. A plurality of first grooves 27a are formed in the front surface of the step 27, and a plurality of second grooves 27b are formed in the back surface of the step 27.

The first groove 27a extends in the X direction. The first groove 27a is open at an end surface 27c of the step 27, which is located on a side opposite to the second surface 22 in the X direction. The shape of the first groove 27a when viewed in the X direction is, for example, a semicircular shape, but may be a V shape. In the present embodiment, eighteen first grooves 27a are formed in the step 27. The plurality of first grooves 27a are aligned in the Y direction. Each first grooves 27a communicates with each first through hole 25. The inner diameter of each first groove 27a is the same as the inner diameter of the first through hole 25. Either the conductor 8a of the signal line 8 or the conductor 9a of the ground line 9 is disposed inside each first groove 27a. Each conductor at the tip end portion of the first electric wire 7 is in contact with each first groove 27a. Each first groove 27a supports each conductor at the tip end portion of the first electric wire 7.

The second groove 27b extends in the X direction. The second groove 27b is open at the end surface 27c of the step 27. The second groove 27b is located on a side opposite to the first groove 27a. The shape of the second groove 27b when viewed in the X direction is, for example, a semicircular shape in a direction opposite to the first groove 27a, but may be a V shape in the direction opposite thereto. In the present embodiment, eighteen second grooves 27b are formed in the step 27. The plurality of second grooves 27b are aligned in the Y direction. Each second grooves 27b communicates with each second through hole 26. The inner diameter of each second groove 27b is the same as the inner diameter of the second through hole 26. Either the conductor 11a of the signal line 11 or the conductor 12a of the ground line 12 is disposed inside each second groove 27b. Each conductor at the tip end portion of the second electric wire 10 is in contact with each second groove 27b. Each second groove 27b supports each conductor at the tip end portion of the second electric wire 10.

The covering member 13 is removed, for example, at a position where it overlaps the end surface 27c of the step 27 in the X direction. That is, the position of the front end surface (not shown) of the covering member 13 in the X direction is approximately the same as the position of the end surface 27c of the step 27 in the X direction. In a case where the first electric wire 7 is an insulated wire, the insulator is removed at the same position, and the conductors of the first electric wires 7 (the conductor 8a of the signal line 8 and the conductor 9a of the ground line 9) are exposed. The covering member 14 is removed, for example, at a position where it overlaps the end surface 27c of the step 27 in the X direction. That is, the position of the front end surface (not shown) of the covering member 14 in the X direction is approximately the same as the position of the end surface 27c of the step 27 in the X direction. In a case where the second electric wire 10 is an insulated wire, the insulator is removed at the same position, and the conductors of the second electric wires 10 (the conductor 11a of the signal line 11 and the conductor 12a of the ground line 12) are exposed.

The pair of guide holes 28 are holes that penetrate the housing 20 in the X direction. The shape of the guide hole 28 when viewed in the X direction is circular. The pair of guide pins 70 are inserted inside the pair of guide holes 28, respectively. The pair of guide holes 28 are formed such that the plurality of first through holes 25 and second through holes 26 are sandwiched therebetween in the Y direction. The inner diameter of each of the pair of guide holes 28 is larger than the inner diameter of each first through hole 25 and the inner diameter of each second through hole 26.

The ground plate 30 (a first ground plate) is a member for reducing the noise generated in the electrical connector 1. The material of the ground plate 30 is, for example, a conductive material formed of an alloy such as beryllium copper. The ground plate 30 has a plate main body 31, a plurality of elastic members 32, and a plurality of elastic members 33. The plate main body 31, the plurality of elastic members 32, and the plurality of elastic members 33 are integrally formed by, for example, press working.

The plate main body 31 is provided on the third surface 23 of the housing 20. The plate main body 31 is fixed to the third surface 23 by, for example, an adhesive. The plate main body 31 is a flat plate that is elongated in the Y direction, and is located above the plurality of first through holes 25. The plate main body 31 may be fixed to the third surface 23 of the housing 20 using a mechanical engagement means.

The number of the plurality of elastic members 32 is the same as the number of the plurality of ground lines 9, which is four pairs (eight). The number of the plurality of elastic members 33 is the same as the number of the plurality of signal lines 8, which is five pairs (ten). The plurality of elastic members 32 and the plurality of elastic members 33 are aligned in the Y direction. A pair of elastic members 32 and a pair of elastic members 33 are alternately aligned in the Y direction. The plurality of elastic members 32 are aligned with the plurality of ground lines 9 in the Z direction, and the plurality of elastic members 33 are aligned with the plurality of signal lines 8 in the Z direction.

The details of the elastic member 32 and the elastic member 33 will be explained with reference to FIG. 5 as well. FIG. 5 is a cross-sectional view of the sub-connector 2 shown in FIG. 3 along line V-V. Each elastic member 32 is a member for electrically connecting the plate main body 31 and the conductor 9a of each ground line 9 to each other. Each elastic member 32 extends from the plate main body 31 toward the conductor 9a of each ground line 9, and is bent to be folded back at a portion where it comes into contact with the conductor 9a. The elastic member 32 has a shape that protrudes toward the conductor 9a of the ground line 9. The shape of the elastic member 32 when viewed in the Y direction is a V shape that protrudes toward the conductor 9a of each ground line 9. Each elastic member 32 has elasticity and is configured to come into elastic contact with the conductor 9a. The elastic member 32 faces the first groove 27a of the step 27 such that the conductor 9a is sandwiched therebetween. The conductor 9a of the ground line 9 is sandwiched between the step 27 and the elastic member 32. The elastic member 32 is in contact with the conductor 9a on the first groove 27a.

Each elastic member 33 is a portion for electrically connecting the plate main body 31 and a conductor of a ground line of another electrical connector (not shown) disposed on the plate main body 31 to each other. Each elastic member 33 extends from the plate main body 31 toward a side opposite to the conductor 8a of each signal line 8, and is bent to be folded back in the middle. The shape of the elastic member 33 when viewed in the Y direction is a V shape in a direction opposite to the elastic member 32. Each elastic member 33 has elasticity. Each elastic member 33 is configured not to come into contact with the conductor 8a of each signal line 8. The elastic member 33 faces the first groove 27a of the step 27 with the conductor 8a sandwiched therebetween. In other words, the step 27 faces the elastic member 33 with the conductor 8a sandwiched therebetween.

Returning to FIGS. 1 and 2, the ground plate 40 (a second ground plate) is a member for reducing the noise generated in the electrical connector 1. The material of the ground plate 40 is, for example, a conductive material formed of an alloy such as beryllium copper. The ground plate 40 is a flat plate that is elongated in the Y direction. The ground plate 40 is located in a through hole (not shown) that penetrates the housing 20 in the X direction. The ground plate 40 is located between the plurality of first electric wires 7 and the plurality of second electric wires 10. A part of the ground plate 40 is located inside the step 27 and is located between the plurality of first grooves 27a and the plurality of second grooves 27b. The ground plate 40 is larger than the plate main body 31 of the ground plate 30 by the step 27. Like the ground plate 30, the ground plate 40 may have elastic members, and the elastic members may be in elastic contact with each conductor 9a of the ground lines 9 or each conductor 12a of the ground lines 12. Alternatively, the elastic member may be configured to come into contact with the ground plate 30. Alternatively, the elastic member may be configured to come into contact with the guide pin 70. In this case, the material of the guide pin 70 is a metal, and the guide pin 70 comes into contact with a ground or the like on the board side. The ground plate 40 does not need to be connected to the ground.

The ground plate 50 is a member for reducing the noise generated in the electrical connector 1. The material of the ground plate 50 is, for example, a conductive material formed of an alloy such as beryllium copper. The ground plate 50 is provided on the fourth surface 24 of the housing 20. The ground plate 50 is fixed to the fourth surface 24 by, for example, an adhesive. The ground plate 50 may be fixed to the fourth surface 24 of the housing 20 using a mechanical engagement means. Like the ground plate 30, the ground plate 50 has elastic members (not shown). The elastic members are in elastic contact with each conductor 12a of the ground lines 12. The ground plate 50 may be provided in the sub-connector 3 adjacent to the sub-connector 2.

The plurality of shield members 60 is a member for reducing the noise generated in the electrical connector 1. The material of the shield member 60 is, for example, a conductive material formed of an alloy such as beryllium copper. Each shield member 60 is located outside the plurality of first electric wires 7 in the Y direction, outside the plurality of second electric wires 10 in the Y direction, between the signal line 8 and the ground line 9 adjacent to each other, and between the signal line 11 and the ground line 12 adjacent to each other. The shield member 60 may be connected to the ground. The end portion of the shield member 60 may be formed into a spring shape, and the end portion may be in contact with the ground plate 30, the ground plate 40, or the ground plate 50. The shield member 60 does not need to be connected to the ground.

The pair of guide pins 70 are pins extending in the X direction. The material of the guide pin 70 is, for example, a metal such as stainless steel. Each guide pin 70 is located within each guide hole 28. The pair of guide pins 70 are provided such that the plurality of first through holes 25 and second through holes 26 are sandwiched therebetween in the Y direction. When the sub-connector 2 is fitted to the mating connector, the positioning of the signal lines and the like is performed by inserting the pair of guide pins 70 into a pair of guide holes (not shown) provided in the mating connector.

The sub-connector 2 configured as described above and the sub-connectors 3 to 5 each having the same configuration as the sub-connector 2 are stacked in the Z direction and held by the frame 6. The frame 6 is an annular member. The material of the frame 6 is, for example, a resin such as polyphenylene sulfide (PPS), polybutylene terephthalate (PBT), or acrylonitrile butadiene styrene (ABS). The stacked sub-connectors 2 to 5 are located inside the frame 6. The frame 6 is in contact with the plate main body 31 of the ground plate 30. The ground plate 30 is held by the frame 6 and the third surface 23 of the housing 20.

As described above, the sub-connector 2 according to the present embodiment has the ground line 9 connected to the ground and the ground plate 30, and the ground plate 30 is in contact with the conductor 9a of the ground line 9. As a result, it is possible to further reduce the noise generated in the sub-connector 2. Furthermore, in the sub-connector 2, the ground plate 30 is in elastic contact with the conductor 9a of the ground line 9 by the elastic member 32 extending from the plate main body 31. As a result, even in a case where the ground plate 30 is provided, there is no need to use a terminal or the like for connecting the ground plate 30 to the ground, and thus the sub-connector 2 can be made smaller. Therefore, according to the sub-connector 2, it is possible to achieve both prevention of increase in transmission loss and miniaturization of the connector.

The sub-connector 2 includes the plurality of first through holes 25 that penetrate the housing 20 in the X direction. As a result, the plurality of first through holes 25 that hold the plurality of first electric wires 7 can be easily formed. Furthermore, the plurality of first through holes 25 can stably hold the plurality of first electric wires 7.

In the sub-connector 2, the housing 20 has the first surface 21 and the second surface 22 located on a side opposite to the first surface 21 in the X direction, the plurality of first through holes 25 are open on the first surface 21 and the second surface 22, and the tip ends of the plurality of first electric wires 7 are exposed from the plurality of first through holes 25 on the first surface 21. The housing 20 has the step 27 that protrudes from the second surface 22 in the X direction, and the conductor 9a of the ground line 9 is sandwiched between the step 27 and the elastic member 32. As a result, the elastic member 32 can be brought into more reliable contact with the conductor 9a of the ground line 9, and the contact of the elastic member 32 with the conductor 9a of the ground line 9 can be stably maintained over a long period of time.

In the sub-connector 2, the step 27 includes the first groove 27a that supports the conductor 9a of the ground line 9, and the elastic member 32 has a shape that protrudes toward the conductor 9a of the ground line 9. As a result, the elastic member 32 can be brought into more reliable contact with the conductor 9a of the ground line 9, and the contact of the elastic member 32 with the conductor 9a of the ground line 9 can be stably maintained over a long period of time.

The sub-connector 2 includes the plurality of second electric wires 10 that have the signal lines 11 and the ground lines 12 connected to the ground, each extend in the X direction, and are arranged in the Y direction. The sub-connector 2 includes the ground plate 40. The housing 20 has the plurality of second through holes 26 for holding the tip end portions of the plurality of second electric wires 10. The plurality of second electric wires 10 are aligned with the plurality of first electric wires 7 in the Z direction, and the ground plate 40 is located between the plurality of first electric wires 7 and the plurality of second electric wires 10. Since the plurality of second electric wires 10 are provided, the amount of signal transmission can be increased. Furthermore, since the ground plate 40 is located between the plurality of first electric wires 7 and the plurality of second electric wires 10, it is possible to prevent the noise generated in the first electric wires 7 from entering the second electric wires 10, and it is possible to prevent the noise generated in the second electric wires 10 from entering the first electric wires 7.

The sub-connector 2 includes the covering member 13 that covers at least the portions of the plurality of first electric wires 7 other than the tip end portions thereof, and the plurality of first electric wires 7 are integrated by the covering member 13. As a result, it is easier to hold the plurality of first electric wires 7 in the plurality of first through holes 25 of the housing 20.

Although the embodiment of the present disclosure is described in detail above, the present disclosure is not limited to the above embodiment and can be applied to various embodiments. For example, in the above embodiment, the first holding portion and the second holding portion are through holes, but the first holding portion and the second holding portion only have to hold the first electric wires 7 and the second electric wires 10. As an example, the first holding portion and the second holding portion may be grooves.

In the above embodiment, the elastic members 32 and 33 have a V shape, but the elastic members 32 and 33 may have other shapes. As an example, the shape of the elastic members 32 and 33 may be a smooth curve shape that protrudes toward the conductor of the ground line, or may be a straight line shape.

In the above embodiment, the sub-connector 2 has the step 27, but the sub-connector 2 may not have the step 27. In this case, the elastic member 32 may be in elastic contact with the ground line 9 by an elastic force to the extent that does not deform the ground line 9.

In the above embodiment, the number of ground lines 9 and the number of elastic members 32 are the same, and one elastic member 32 is in contact with the conductor 9a of one ground line 9, but the number of ground lines 9 may be different from the number of the elastic members 32. In this case, for example, one elastic member 32 may be in contact with two adjacent ground lines 9.

In the embodiment described above, the electrical connector 1 includes the plurality of sub-connectors 2 to 5, but it is sufficient that the electrical connector 1 includes at least one sub-connector (for example, the sub-connector 2). In this case, one sub-connector constitutes the electrical connector.

What is claimed is:

1. An electrical connector comprising:
a plurality of first electric wires including a first signal line and a first ground line connected to a ground, wherein each of the plurality of first electric wires extends in a first direction and the plurality of first electric wires are arranged in a second direction intersecting with the first direction;
a housing including a first holding portion that holds each tip end portion of the plurality of first electric wires; and
a first ground plate including a plate main body provided on the housing,
wherein the first holding portion holds each conductor at each tip end portion of the plurality of first electric wires,
wherein the first ground plate includes an elastic member extending from the plate main body toward the conductor of the first ground line, and
wherein the elastic member is configured to come into elastic contact with the conductor of the first ground line.

2. The electrical connector according to claim 1,
wherein the first holding portion includes a plurality of through holes that penetrate the housing in the first direction, and
wherein each tip end portion of the plurality of first electric wires is received in each of the plurality of through holes.

3. The electrical connector according to claim 1,
wherein the housing includes a first surface and a second surface located on a side opposite to the first surface in the first direction,
wherein the first holding portion is open on the first surface and the second surface,
wherein each tip end of the plurality of first electric wires is exposed from the first holding portion on the first surface,
wherein the housing includes a step that protrudes from the second surface in the first direction, and
wherein the conductor of the first ground line is sandwiched between the step and the elastic member.

4. The electrical connector according to claim 3,
wherein the step includes a groove that supports the conductor of the first ground line, and
wherein the elastic member has a shape that protrudes toward the conductor of the first ground line.

5. The electrical connector according to claim 1,
wherein the elastic member has a V shape that protrudes toward the conductor of the first ground line.

6. The electrical connector according to claim 1, further comprising:
a plurality of second electric wires including a second signal line and a second ground line connected to a ground, wherein each of the plurality of second electric wires extends in the first direction and the plurality of second electric wires are arranged in the second direction; and
a second ground plate,
wherein the housing includes a second holding portion that holds each tip end portion of the plurality of second electric wires,
wherein the plurality of second electric wires are aligned with the plurality of first electric wires in a third direction intersecting with both the first direction and the second direction, and
wherein the second ground plate is located between the plurality of first electric wires and the plurality of second electric wires.

7. The electrical connector according to claim 1, further comprising a covering member that covers at least portions of the plurality of first electric wires other than each tip end portion thereof,
wherein the plurality of first electric wires are integrated by the covering member.

8. The electrical connector according to claim 6,
wherein the housing includes a first surface and a second surface located on a side opposite to the first surface in the first direction,
wherein the housing includes a step that protrudes from the second surface in the first direction,
wherein the step includes a first groove that supports the conductor of the first ground line, and a second groove that supports the conductor of the second ground line.

9. The electrical connector according to claim 8,
wherein the first groove is located on a side opposite to the second groove.

10. The electrical connector according to claim 1, further comprising:
a pair of guide pins to connect to a mating connector,
wherein the pair of guide pins sandwich the first holding portion therebetween in the second direction.

11. The electrical connector according to claim 1,
wherein the plurality of first electric wires include a plurality of the first ground lines,
wherein the first ground plate includes a plurality of the elastic members, and
wherein each elastic member is configured to come into elastic contact with the conductor of each first ground line.

12. The electrical connector according to claim 1, further comprising:
a shield member located between the first signal line and the first ground line adjacent each other.
